(19) United States
(12) Patent Application Publication
(10) Pub. No.: US 2007/0185260 A1
(43) Pub. Date: Aug. 9, 2007

(54) Heat-resisting silicone materials containing inorganic ceramic hollow microspheres

(76) Inventors: Hsi-Liang Lin, Taipei city (TW); Fu-Ter Huang, Taipei city (TW)

Correspondence Address: TROXELL LAW OFFICE PLLC, SUITE 1404, 5205 LEESBURG PIKE, FALLS CHURCH, VA, 22041, US

(21) Appl. No.: 11/346,362

(22) Filed: Feb. 3, 2006

(51) Int. Cl. C08L 83/04

(52) U.S. Cl. 524/588; 524/430; 524/431; 524/436; 524/437

(57) ABSTRACT

The present invention relates to heat-resisting silicone materials containing inorganic ceramic hollow microspheres, which comprising an inorganic hollow microsphere substrate consisted of inorganic ceramic hollow microsphere, silicone rubber and other compounds, wherein the inorganic ceramic hollow microspheres with diameters of 80-100 μm, and complex ceramic powders of nano-grade. The silicone rubber has heat-resisting temperature up to 450° C., so that the heat-resisting temperature of resultant silicone materials of the invention may be raised to 450° C. even higher. Furthermore, the heat energy can be converted to thermal radiation with the broad wavelength in frequency domain of about 2-80 μm by the silicone materials of the invention.

### TECHNICAL FIELD

The present invention relates to a heat-resisting silicone material, particularly to a heat-resisting silicone material containing inorganic ceramic hollow microspheres.

### BACKGROUND ART

In the nowaday fashions of working, people almost sit at the desk with a fixed posture for a long time, which results in poor blood circulation. For most people lacking of sufficient exercise and activation of blood circulation, lumbago and notalgia have become the most common symptoms in the neuropathy. Some people tried to release the paining and other discomfortable symptoms by applying painkiller plaster or massage. In the near years, an infrared radiation instrument that convert the electric energy to heat energy, which is further converted to infrared radiation, has been developed to accelerate the blood circulation and alleviate the painful symptoms in discomfortable area by the infrared irradiation. However, the effects of current infrared radiation instruments are limited by the narrow range of infrared wavelength emitted by the instruments, with a range between 4-14 μm. For that human body is a complex collection of various energy with different wavelength ranges, the energy with narrow infrared wavelength range emitted by the prior infrared radiation instruments could only occupy a small part of bioenergy in human body.

Additionally, the heat-resisting temperatures of known silicone materials are commonly at the range of 100° C. to 200° C., which not able to meet the request of thermal insulation from heating elements widely used in electronic technology. Therefore, it is also a need to develop a silicone material with high heat-resisting temperature.

### DISCLOSURE OF THE INVENTION

To overcome the disadvantages of current silicone materials described above, the inventors have developed a heat-resisting silicone material, which can convert the heat energy to thermal radiation with the broad wavelength in frequency domain of about 2-80 μm that acts to deep tissue of human body then improves blood circulation and the efficacy of metabolism.

For achieving the objects, the present invention provides a heat-resisting silicone material containing inorganic ceramic hollow microspheres, which made of an inorganic hollow microsphere substrate consisted of 10˜20% (v/v) of inorganic ceramic hollow microspheres, 40˜50% of silicone rubber, 5˜10% (v/v) of zirconium dioxide, 5˜15% (v/v) of aluminum oxide, 5˜15% (v/v) of silicon dioxide, 5˜15% (v/v) of zinc oxide, and 3˜7% (v/v) of barium titanate using the silicone rubber as binder, in which the inorganic ceramic hollow microspheres having diameters of 80-100 μm; and complex ceramic fine powder of nanometers at 5˜15% (v/v) mixed with 85˜95% (v/v) of the inorganic hollow microsphere substrate to form the heat-resisting silicone material containing inorganic ceramic hollow microspheres.

The silicone rubber component, which used as a binder, has heat-resisting temperature up to 450° C., so that the resultant silicone material has heat-resisting temperature of 450° C. or even higher and exhibits excellent thermal insulating effect.

The inorganic ceramic hollow microspheres have diameters of 80 to 100 μm and also exhibit thermal insulating property, which confer the heat transfer rate less than 315 kcal/m.hr.° C. As described, the complex ceramic fine powders of nanometers included in the present heat-resisting silicone material contain several nano-graded metal oxides, which including 12˜24% (v/v) of nano-graded zirconium dioxide, 18˜30% (v/v) of nano-graded aluminum oxide, 18˜30% (v/v) of nano-graded silicon dioxide, 18˜24% (v/v) of nano-graded zinc oxide, and 10˜18% (v/v) of nano-graded barium titanate, and cause that the heat energy can be converted to thermal radiation with the broad wavelength in frequency domain of about 2-80 μm by the materials of the invention.

The present silicone materials can be applied to an energy irradiation instrument. Moreover, they can be used as the heat insulating materials of heater, which make it possible that users may conveniently take up the heater without worrying the high-temperatured surface of the heater. On the other hand, the present silicone materials can convert the heat energy to thermal radiation with the broad wavelength in frequency domain of about 2-80 μm, which may be used in the irradiation of human body to improves blood circulation and metabolism efficacy, and further to alleviate the discomfortable symptoms.

### DESCRIPTION OF DRAWINGS

FIG. 1 shows the components of the silicone material of, the invention.

FIG. 2 shows the internal view of the present silicone material.

In which, the symbol (a): the inorganic ceramic hollow microspheres; (b): the silicone rubber; (c): zirconium dioxide; (d): aluminum oxide; (e): silicon dioxide; (f): zinc oxide; (g): barium titanate; 1: an energy irradiation instrument; 10: the base; 20: the setting plate; 21: the resistance; 30: the heat insulation plate; 40: the protection network; 50: the cap; 60: the insulation frame.

### Preferred Embodiments

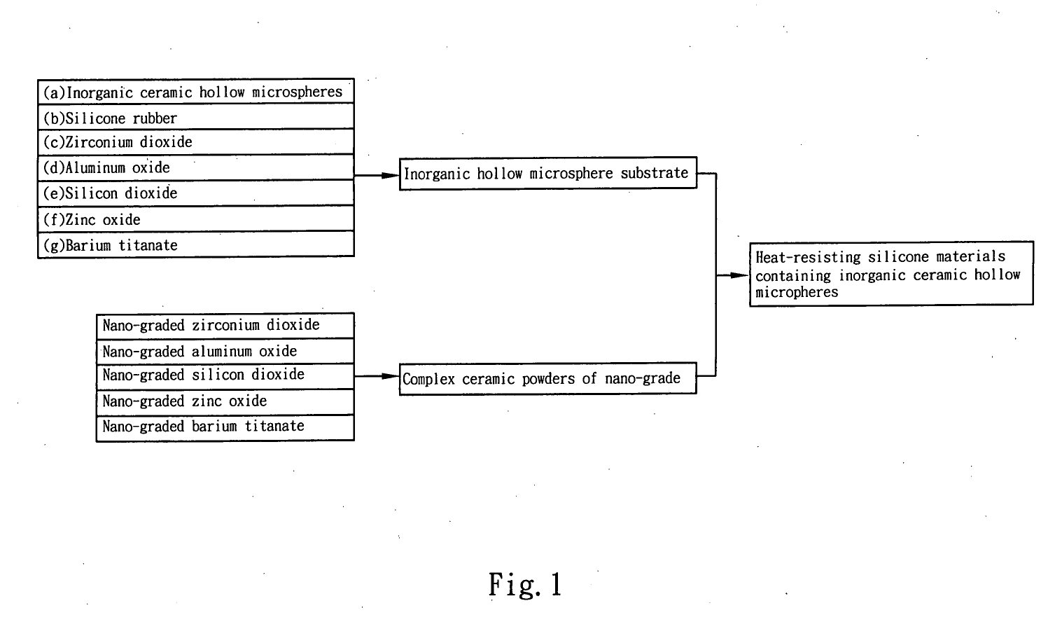

As shown in FIG. 1, the present invention provides a heat-resisting silicone material containing inorganic ceramic hollow microspheres were made of an inorganic hollow microsphere substrate consisted of 10˜20% (v/v) of inorganic ceramic hollow microspheres (a), 40˜50% of silicone rubber (b), 5˜10% (v/v) of zirconium dioxide (c), 5˜15% (v/v) of aluminum oxide (d), 5˜15% (v/v) of silicon dioxide (e), 5˜15% (v/v) of zinc oxide (f), and 3˜7% (v/v) of barium titanate (g); and a complex ceramic fine powder of nanometers at 5˜15% (v/v) mixed with 85˜95% (v/v) of the inorganic hollow microsphere substrate to form the resultant heat-resisting silicone material.

The silicone rubber (b), which used as the binder, has heat-resisting temperature up to 450° C. so as to make the heat-resisting temperature of resultant silicone materials of the invention be raised to 450° C. even higher.

The inorganic ceramic hollow microspheres (a) have diameters of 80 to 100 μm and exhibit thermal insulating property, which confer the heat transfer rate less than 315 kcal/m.hr.° C. The described complex ceramic nano-fine powders contain several nano-graded metal oxides, which including 12˜24% (v/v) of nano-graded zirconium dioxide, 18˜30% (v/v) of nano-graded aluminum oxide, 18˜30% (v/v) of nano-graded silicon dioxide, 18˜24% (v/v) of nano-graded zinc oxide, and 10˜18% (v/v) of nano-graded barium titanate, and result that the materials of the invention can convert heat energy to thermal radiation with the broad wavelength in frequency domain of about 2-80 μm for the improvements in advancing heat-resistant and thermal insulating properties.

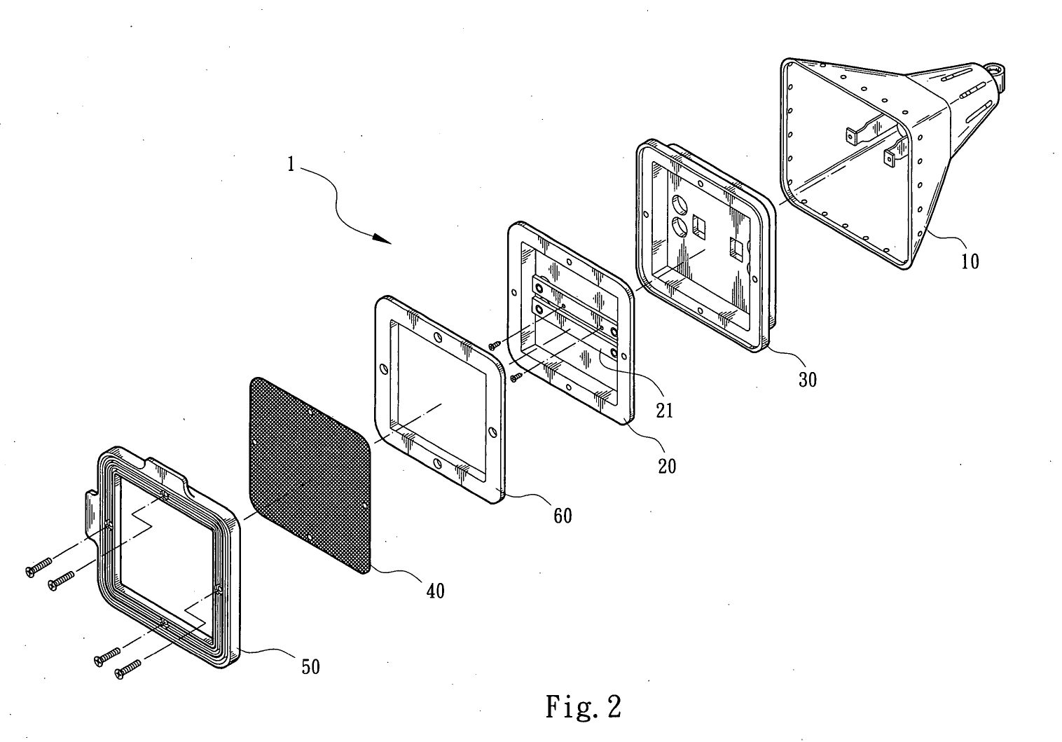

As shown in FIG. 2, the silicone materials of the invention can be used in an appropriate heating article for the use as heat insulator. For instance, the present silicone material may be applied to an energy irradiation instrument 1, Which comprising: a base 10, a setting plate 20 equipped with a resistance 21, which connecting to external electric circuit, a heat insulation plate 30, which made of the silicone materials of the invention, mounted between the setting plate 20 and the base 10, with a protection network 40 and cap 50 equipped beside the setting plate 20, and a insulation frame 60, which made of the silicone materials of the invention, placed between the setting plate 20 and the cap 50.

When electric current is transported to the resistance 21, the resistance 21 converts electric energy to thermal energy. The heat insulation plate 30 and the insulation frame 60, which made of the silicone materials of the invention, will convert the heat energy to a thermal radiation with the broad wavelength in frequency domain of about 2-80 μm. At that time, for the properties of the silicone materials with heat-resisting temperature of above 450° C. and heat transfer rate less than 315 kcal/m.hr.° C., the heat from the resistance 21 and other elements equipped therewith may be insulated and won't be transmitted to the residual elements, by which users could conveniently carry and move the energy irradiation instrument 1 without worrying that they may be burned by the high temperature of the shell.

1. A heat-resisting silicone materials containing inorganic ceramic hollow microspheres, which is characterized that made of:
an inorganic hollow microsphere substrate consisted of 10˜20% (v/v) of inorganic ceramic hollow microspheres, 40˜50% of silicone rubber, 5˜10% (v/v) of zirconium dioxide, 5˜15% (v/v) of aluminum oxide, 5˜15% (v/v) of silicon dioxide, 5˜15% (v/v) of zinc oxide, and 3˜7% (v/v) of barium titanate using the silicone rubber as binder, in which the inorganic ceramic hollow microspheres with diameters of 80-100 μm; and
a complex ceramic fine powder of nanometers at 5˜15% (v/v) mixed with 85˜95% (v/v) of the inorganic hollow microsphere substrate.

2. The heat-resisting silicone materials of claim 1, wherein the complex ceramic powders comprising 12˜24% (v/v) of nano-graded zirconium dioxide, 18˜30% (v/v) of nano-graded aluminum oxide, 18˜30% (v/v) of nano-graded silicon dioxide, 18˜24% (v/v) of nano-graded zinc oxide, and 10˜18% (v/v) of nano-graded barium titanate.

3. The heat-resisting silicone materials of claim 1, in which the silicone rubber has heat-resisting temperature up to 450° C.

4. The heat-resisting silicone materials of claim 2, in which the silicone rubber has heat-resisting temperature up to 450° C.
